(19) United States
(12) Patent Application Publication
(10) Pub. No.: US 2020/0290321 A1
(43) Pub. Date: Sep. 17, 2020

(54) COMPOSTABLE AND ENVIRONMENTALLY FRIENDLY PACKAGING FOR A FROZEN PRODUCT

(71) Applicant: FRoSTA Aktiengesellschaft, Bremerhaven (DE)

(72) Inventor: Urban BUSCHMANN, Neustadt (DE)

(73) Assignee: FRoSTA Aktiengesellschaft, Bremerhaven (DE)

(21) Appl. No.: 16/817,224

(22) Filed: Mar. 12, 2020

(30) Foreign Application Priority Data
Mar. 13, 2019 (DE) 202019101435.0
Jul. 15, 2019 (EP) 19186255.6

(51) Int. Cl. B32B 23/06; B65D 75/26; B65D 65/46; B65D 65/42; A23L 3/36

(52) U.S. Cl. CPC B32B 23/06; B65D 75/26; B65D 65/466; B65D 65/42; A23V 2002/00; B32B 2255/12; B32B 2255/26; B32B 2439/70; A23L 3/364

(57) ABSTRACT

The present invention relates to a packaging, particularly for frozen food, which particularly comes from renewable sources, and which particularly does not compete with food production.

The problem is solved by a packaging for a frozen product, wherein at least 50 wt % of the packaging and/or its main component is formed of kraft paper and/or kraft cardboard, particularly unbleached, and/or paper, particularly fresh fiber paper.

### BACKGROUND

### Technical Field

The present invention relates to a packaging, particularly for frozen food, which particularly comes from renewable sources, and which particularly does not compete with food production. The material can be recovered homogeneously after use in a simple manner and without a great effort through recycling and also allows other disposal options, for example by composting, without any adverse effects on the environment. These positive properties of the selected packaging can be visually supported by brown hues of an unbleached paper and/or cardboard packaging, which can optionally be printed on, particularly is only partially printed on.

### Background Information

A packaging for frozen food is subject to special requirements with respect to the exposure to moisture and the long storage time. Deep freeze logistics is “moist” logistics, since water vapor precipitates on the packaging surface due to temperature variations. An absorbent surface absorbs the water and can adversely alter the mechanical properties of the packaging.

Therefore, in prior art, cardboard packaging is used in the field of frozen foods, but virtually no flexible paper packagings are used. It is known, however, that paper packagings laminated with film from fossil sources or biofilm are used. It is a disadvantage in this context that these cannot be recycled as pure paper fraction, particularly because the 5% limit for the minor component in flexible materials is typically not met. It is also known that a paper material is used in processing in flow wrappers, wherein the elastic properties of paper needed for such processing are in advance achieved in a special process by creating a mini-crease pattern in the microstructure of the material, as described in EP 1 985 437 B1, for example. But such a method or packaging is as yet only used in dry products. In the field of firm cardboard materials, packagings are used which can be recycled as paper despite their plastic coating, because they can typically meet the 5% limit due to the great thickness of the cardboard material. But it is a disadvantage that the commercially available materials include so-called hard bond adhesives and are therefore not compostable. Firm cardboard-based materials made of recycled material are also offered, but these are disadvantageous for food products due to their contamination with mineral oil.

Numerous packaging materials can be found in the market which consist of plastic or bleached paper/cardboard with paper-like print. The haptics of these materials are also designed to be similar to paper, in part by using special varnishes. The objective is to present consumers with the naturalness they expect, having “the look and feel of paper when touched” but without being sustainable.

Plastic materials such as PET, PE, or PP, or combinations thereof are frequently used as packaging in the frozen food industry, which results in many advantages. They represent an impermeable material, preventing semi-liquid and oily components from leaking through the packaging Plastics have elastic properties and can be processed well by flow wrappers. The fact that they can be bent around very small radii in a cold and therefore humid environment without tearing at so-called shoulders of the packaging machines is of particularly importance in this context. Furthermore, plastics are highly resistant to moisture. On the other hand, plastics have quite evident disadvantages. On the one hand, mineral oil as the source of these materials is a finite resource and is not available to mankind forever. On the other hand, the use of plastics is very harmful for the environment. Few countries only have a well-functioning recycling system, which means that a large quantity of plastics is disposed of into the environment. For example, about 8 million tons of plastic are dumped into the oceans annually (2018), and this development must be stopped as a matter of urgency. Plastics also cause relatively high climate emissions during their production, in kg Co2e/kg material (ecoinvent 3.1 and/or 3.2), e.g.: polyethylene causes 2.91 kg Co2e/kg polyethylene; polypropylene causes 2.65 kg Co2e/kg polypropylene; polyethylene terephthalate causes 3.52 kg Co2e/kg polyethylene terephthalate; polystyrene causes 3.87 kg Co2e/kg polystyrene; aluminum foil causes 9.89 kg Co2e/kg aluminum foil. When considering the urgent problems of mankind, like littering of the oceans, the disadvantages of using plastics predominate, and these are remedied by the invention.

### SUMMARY

The present invention relates to a packaging, particularly for frozen food, which particularly comes from renewable sources, and which particularly does not compete with food production. The problem is solved by a packaging for a frozen product, wherein at least 50 wt % of the packaging and/or its main component is formed of kraft paper and/or kraft cardboard, particularly unbleached, and/or paper, particularly fresh fiber paper.

### BRIEF DESCRIPTION OF THE SEVERAL VIEWS OF THE DRAWINGS

FIG. 1 is a diagrammatic view of an arrangement for testing the resistance to puncture of the packaging in accordance with the disclosure;

FIG. 2 is a diagrammatic view of an arrangement for testing corner stability of the package in accordance with the disclosure; and

FIG. 3 is a diagrammatic view of packaging in accordance with the present disclosure in the form of kraft paper being folded into bags.

### DETAILED DESCRIPTION

It is the problem of the invention to overcome the disadvantages of using plastics and the other materials mentioned as comprehensively as possible by replacement with a packaging material from renewable sources, but particularly still be able to use common packaging machines and/or recipes. As is known from WO 2017/083738 A2, packagings for frozen food products can be formed of kraft paper and an insulating layer based on natural fibers, namely bast fibers. Furthermore, transport devices for frozen food products formed of kraft paper and a membrane based on biodegradable plastic are described in WO 2016/182492 A1.

The problem is particularly solved by using unbleached kraft paper or cardboard. Climate emissions are in principle at least by half lower for paper than for plastics. Climate emissions of the paper or cardboard can be lowered even more significantly by avoiding the bleaching process (according to ecoinvent 3.1 and/or 3.2):
Unbleached paper: 0.82 kg CO2e/kg (bleached paper: 1.38 kg CO2e/kg)
Unbleached cardboard 0.93 kg Cote/kg (bleached cardboard: 1.1 kg CO2e/kg)

The preferred use of unbleached paper or cardboard is accompanied by meeting the consumers' expectation of naturalness in appearance and haptics. The color spectrum of the surface of unbleached cardboards and papers was measured using a spectrophotometer (x-rite eXact), and the following values were obtained:
Papers 50 to 70 g/m²: L=63.9; a=10.0; b=22.4; delta E according to CIEDE2000=1.9
Cardboard 244 to 356 g/m²: L=60.4; a=8.9; b=19.7; delta E according to CIEDE2000=1.5

Preferred are surfaces having L between 30 and 60 and/or a between 0 and 25 and/or b between 5 and 127 and/or delta E CIEDE2000 between 1 and 3, particularly measured with an x-rite eXact spectrophotometer.

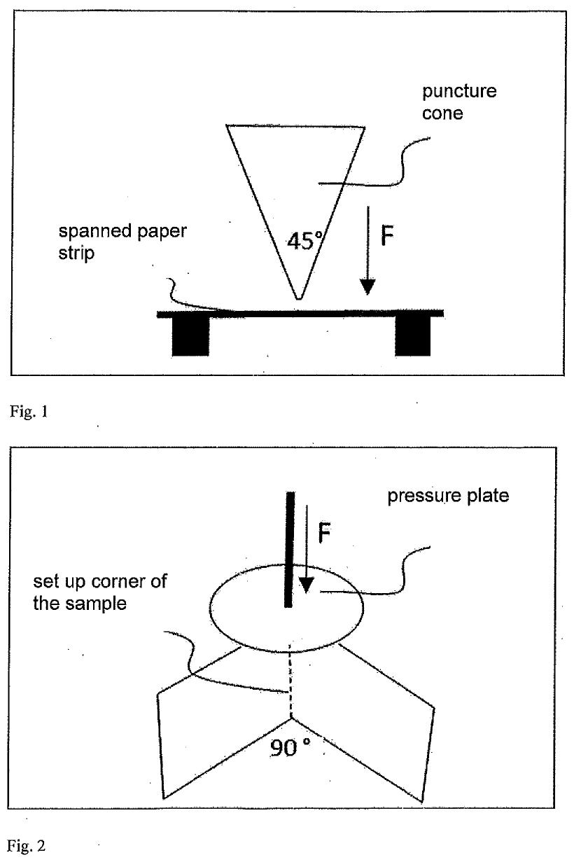

As regards the mechanical properties and exposure to moisture in deep freeze logistics, it was surprisingly found that kraft papers and kraft cardboards display an increased puncture resistance when moistened. In lab tests, a kraft paper was stored at 23° C. and a relative humidity (rh) of 50% (“dry”) on the one hand and at 23° C. and a relative humidity (rh) of 80% (“moist”) on the other hand and stretched out flat in a tensile compression machine and treated with a cone (45° angle). A force over time diagram was recorded and the point at which the cone punctured the material was measured. Test conditions: Zwick structograph (Zwick Roell 616451), sample width: 60 mm, span between supports: 62 mm, constant penetration rate of 7.5 mm/min, radius of the flattened cone tip: 1.5 mm, pre-load 1 N. The maximum force until puncturing the sample or until reaching the maximum path of the test specimen of 6.5 mm was measured. (see FIG. 1 for the test arrangement during measurement). The samples were previously stored in a “memmert HPP 110” device for 3 hours under the conditions for “dry” and “moist” as specified above. The following puncture force results were obtained (at a retry count of n=20, confidence level of the variety of mean values as determined using a t-test is at least 99%):
Kraft paper 50 g/m²: dry 8.3 N, moist: 10.0 N
Kraft paper 70 g/m²: dry 12.6 N, moist: 17.1 N

The increase in puncture resistance shows a particular suitability of the kraft paper for use in the deep freeze section, since exposure to moisture is even advantageous in logistics. According to the invention, it was also found during the measurements that moistening the kraft paper increases its suitability for machine processing during filling with frozen components because the elasticity of the moistened kraft paper increases. The force-path diagram was recorded during the measurements at the Zwick structograph mentioned above. It is known from materials testing that the angle of inclination of the curve is a measure of elasticity. The steeper or greater the angle of inclination, the more brittle or harder and thus the more fragile is the material. The following angles of inclination in the force-path diagram were achieved for a kraft paper of 50 g/m²:
Unbleached “dry” kraft paper: 75°,
Unbleached “moist” kraft paper: 67°.

The increase in elasticity is on the one hand an important factor for machine runability, on the other hand it is a prerequisite for mechanical suitability in deep freeze logistics. The packaged frozen product is subjected to pressure and impact stresses, particularly because the frozen components are hard and can have sharp edges at a typical frozen temperature of −18° C. The suitability, according to the invention, of unbleached kraft paper for deep freeze logistics was demonstrated in a lab test. Kraft paper strips of 49.5×31.5 cm were shaped into a bag, filled with 400 g of ribbon noodles (11×60 mm), and the closed bag was exposed to a temperature of −40° C. with circulating air for 60 min. Then the individual bags were dropped from a height of 1 m directly onto the floor, a concrete floor coated with synthetic resin. Holes or breaks were determined and analyzed in the analysis step. The following results were obtained for 10 drops:
Kraft paper unbleached, 60 g/m²: 1 slight crack about 10 mm in length
Paper from pulp, unbleached, 60 g/m²: 6 medium to larger cracks (greater than 10 mm, up to 50 mm in length).

Surprisingly, a special suitability for frozen foods was also found in the field of kraft cardboards. Here, the so-called corner stability was measured, a measure that can be used to calculate the mechanical stability of cardboard boxes packed onto a pallet. Kraft cardboard samples having an edge length of 8.5×3 cm were cut with one edge in the fiber direction and one edge against the fiber direction, and a grooving was applied at the center, in some of the samples parallel to the fiber direction and in some other samples transverse to the fiber direction using a Warner Bretzler blade. The samples were placed under the blade (thickness 3 mm, tip height 3 mm) and pressed into the table recess at a pre-load of 1 N and a rate of 10 mm/min (width 3.6 mm). This formed the edge or corner for the test. The samples were air-conditioned for 3 hours at 80% rh at 20° C. in the conditioning cabinet (see above). Then the sample was folded along the grooving, thereby forming an edge (edge simulates the force-bearing edge of a folded box on the pallet). The samples were positioned in a structograph (Zwick Roell, see above) on a base pre-milled for the purpose which had two grooves arranged at a right angle to each other into which the box angled by 90° was placed to be positioned as shown in FIG. 2. Then a force was applied to the corner of the sample using a round punch having a diameter of 36 mm at a feed of 10 mm/min. The test compared an unbleached kraft cardboard and a commercially available hard-glued (box mixed with hydrophobic agents) white GC cardboard box of the same grammage. The following results were obtained for 80% rh and 23° C.:
Kraft cardboard, unbleached, 244 g/m²:
   Groove in the fiber direction: 36.4 N
   Groove against the fiber direction: 46.9 N
Bleached and hard-glued commercially available box for comparison, 244 g/m²
   Groove in the fiber direction: 30 N
   Groove against the fiber direction: 35.5 N

The surprisingly found relative resistance to moisture, combined with the increase in mechanical properties of the kraft paper or kraft cardboard allows the direct packaging of frozen vegetables according to the invention. Other frozen components can likewise be packaged directly in kraft papers, kraft cardboards, particularly if uncoated and/or unprinted at least inside, for example frozen chicken meat cuts, frozen rice, and the like. This feasibility was also established in a storage test based on deep-freeze logistics for the following products:
Test 1: Frozen vegetables (carrots, sweet pea pods, cauliflower, mushrooms, diced tomatoes)
Test 2: Frozen mixture, consisting of 70% chopped spinach and 30% of a cream sauce (creamed spinach)
Test 3: Frozen penne noodles coated in a cheese cream sauce (freezing point above −10° C.).

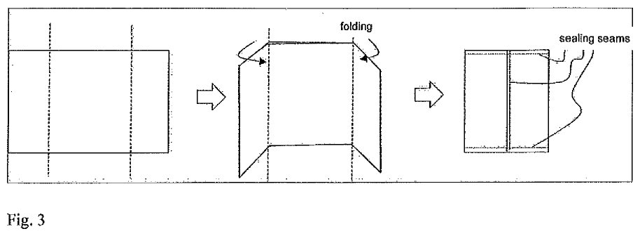

The products were packaged in kraft paper folded into bags, without further coating, as shown in FIG. 3 and closed with sticky tape. No moisture stains were found on the outer and inner paper surfaces after frozen storage of 12 months.

For oil-containing components or product components having a low freezing point, the kraft paper can be laminated with a mechanically conditioned paper. For producing this mechanically conditioned paper, cellulose fibers, particularly fresh fibers, are ground for papermaking, compressed mechanically and using steam, particularly under high pressure, and smoothened by rolling. Good resistance to fat and good resistance to water is achieved by compression, particularly to more than 900 kg/m, particularly to more than 1000 kg/m³, and/or particularly 1300 kg/m³. Regular paper typically has a density of about 700 kg/m³. The compressed paper can be laminated onto the kraft paper and/or joined therewith. Particularly, a lining of the packaging with compressed paper is provided and/or produced. The material can be joined, for example with kraft paper or kraft cardboard, for example using an adhesive, particularly during laminating. It can be configured as a full area joint or just a spot joint or linear joint. This then represents a coating. The mechanically compressed paper is particularly unbleached and/or unprinted. Particularly, the compressed paper is, and/or the fibers of which the compressed paper is formed are, not chemically treated and/or not impregnated. Particularly, the compressed paper is, and/or the fibers of which the compressed paper is formed are, only treated mechanically to produce the compressed paper.

The problem is solved by a packaging for a frozen product, wherein at least 50 wt % of the packaging and/or its main component is formed of kraft paper and/or kraft cardboard, particularly unbleached, and/or paper, particularly fresh fiber paper.

Particularly, the packaging comprises at least one layer of kraft paper and/or kraft cardboard and at least one layer of compressed paper and/or cellophane joined therewith, at least in sections, by laminating, wherein the at least one layer of compressed paper and/or cellophane is particularly exposed in the interior of the packaging, and/or wherein the packaging has at least one layer absorbent and/or repellent to moisture, particularly to water vapor, and/or oil, particularly between the layer of kraft paper and/or kraft cardboard and the at least one layer of compressed paper and/or cellophane.

The packaging particularly has less than 10 wt %, particularly less than 5 wt %, particularly no CTMP and less than 10 wt %, particularly less than 5 wt %, particularly no BCTMP, and/or the packaging particularly has no impregnation and/or the packaging is particularly compostable.

The overall content of CTMP and BCTMP in the packaging particularly is less than 15 wt %, particularly less than 10 wt %, particularly less than 5 wt %.

The packaging particularly has less than 10 wt %, particularly less than 5 wt %, particularly no TMP.

The overall content of TMP, CTMP, and BCTMP in the packaging particularly is less than 15 wt %, particularly less than 10 wt %, particularly less than 5 wt %.

The term compostable, as used herein, means compostability according to the composting standard EN 13432.

The packaging particularly includes no film and/or the kraft paper and/or the compressed paper is not laminated extensively, particularly not across more than 5% of its two-dimensional extension, particularly not at all laminated with a film.

Particularly, the packaging comprises at least one layer of kraft paper and/or kraft cardboard and at least one layer of compressed paper joined therewith, at least in sections, by laminating, wherein the at least one layer of compressed paper is particularly exposed in the interior of the packaging, and/or wherein the packaging has at least one layer absorbent and/or repellent to moisture, particularly to water vapor, and/or oil, particularly between the layer of kraft paper and/or kraft cardboard and the at least one layer of compressed paper. If both an absorbent and a repellent layer are present and/or the at least one layer has at least one absorbent and one repellent side and/or layer, the absorbent side is particularly arranged facing the interior of the packaging.

If the packaging is a tray for microwave and oven preparation, the compressed paper and the moisture absorbent layer are particularly arranged at the bottom of the tray, particularly extending across the entire bottom. Particularly, these layers also extend at least 1 cm from the bottom upwards on the sides.

By providing a layer of compressed paper and a moisture absorbent layer, the tray can also be used for preparation of a dish stored therein in the oven or in the microwave without having to follow restrictions with respect to the type of food and without the tray soaking during preparation.

In a bag, the compressed paper is particularly arranged as a full-area lining on the inner surface of the bag. Optionally, a moisture absorbent layer can be provided between the compressed paper and the kraft cardboard or, particularly in a bag, kraft paper.

The moisture absorbent and/or repellent layer and/or paper do not need to have a specific thickness. It is sufficient that a paper having a grammage of 4 g/m² and a quantity of 9 g/m² of moisture absorbent layer are used.

The moisture absorbent and/or repellent layer can be part of a glued joint or lamination of kraft cardboard and/or paper and compressed paper.

Cellophane and/or a combination of cellophane and compressed paper can be used instead of compressed paper. This is particularly advantageous when using oil-containing components or components such as soy sauce. Cellophane is a well repelling barrier to edible oil, while the highly compressed paper has a very good repellent barrier effect on soy sauce. At least a 12-hour resistance to these foods was established in tests.

Particularly advantageously, the packaging is a folded box, the bottom part of which can be removed and represents a tray after removal. The packaging has at least one perforated line and/or a breakaway tab for easier removal. The bottom part of the packaging is then particularly configured as a tray, particularly for microwave and oven preparations.

Alternatively, the packaging can include a tray completely enclosed by the packaging, which tray and the food arranged therein can be removed from the packaging after the packaging is opened.

The moisture absorbent layer can fully cover the entire surface or be configured as layer which is present at spots or in strips or sections. Particularly, the maximum distance between sections of moisture absorbent material, at least in a bottom surface of the packaging, particularly a tray, is 2 cm, particularly 1 cm. Particularly, the moisture absorbent layer extends over, and/or moisture absorbent material is arranged over at least 70% of at least a bottom surface of the packaging, particularly a tray. The moisture and/or oil repellent and/or oil resistant layer can particularly cover the entire surface and/or is a layer that is present in sections, particularly over at least 30%, particularly over at least 80% of the extension of the packaging and/or a surface of the packaging.

Moisture absorbent materials can particularly one or more from the following list, and/or the moisture absorbent layer can be formed by one or more from the following list:

Calcium, calcium carbonate, calcium hydroxide, silica gel, silica gel, metallo-organic frameworks (MOFs, e.g. Zn4O(BDC)3)), chalk; kaolin (with kaolinite: Al2Si2O5 (OH)4), alkali lignosulfonate, zeolite, clinoptilolite, Ca-, K- and/or Na-clinoptilolite, polyacrylates, hydrogel forming polymers (e. g. polyacrylamide, polyvinyl pyrrolidone, amylopectin, gelatin, cellulose, copolymer of acrylic acid (e.g. propenoic acid, H2C═CH—COOH), alkali salts of acrylic acid, sodium acrylate (sodium salt of acrylic acid, H2C═CH—COONa), acrylamide)

The substance(s) is/are particularly contained in the packaging in bound form, particularly bound by means of at least one oven and/or microwave resistant binding agent, particularly by means of one or more acrylates, and/or the moisture absorbent layer is formed by one or more of the substances of the above list, particularly bound by means of at least one oven and/or microwave resistant binding agent, particularly by means of one or more acrylates.

Particularly, in this case no layer of (dissolved) polymers (as a barrier) is required and advantageously is not present.

A packaging having a coating and/or lining of compressed paper is even microwaveable and/or can be used in an oven. This means that the, particularly frozen, food product in the packaging can be heated and/or warmed up in the packaging. The compressed paper particularly is not kraft paper and/or kraft cardboard. The compressed paper particularly has a roughness value and/or SS roughness value according to ISO 8791-2 of less than 250, particularly of less than 100, and/or a PPS (roughness according to Parker Print Surf) of less than 4 μm, particularly of less than 2 μm, all ISO as amended at the date of filing, and/or particularly at a relative humidity of 50% and/or a temperature of 23° C.

Furthermore, a commercially available polyvinyl alcohol and/or vinyl alcohol copolymer may be applied to increase the resistance to fat.

Advantageously, the proportion of polyvinyl alcohol and/or vinyl alcohol copolymer is in the range from 1 to 20, particularly from 5 to 15, particularly from 7 to 8, g/m².

Particularly, the packaging does not comprise any polymers, except for the polyvinyl alcohol and/or vinyl alcohol copolymer and except for the moisture absorbent layer. As preferred in some use cases, particularly if the packaging is not intended for preparation of a food product contained therein in a baking or microwave oven. the packaging particularly does not comprise any polymers except for polyvinyl alcohol and/or vinyl alcohol copolymer. As preferred in some use cases, particularly if the packaging is not intended to absorb, or does not contain, substances having a fat content on their outer surfaces of more than 5%, which are liquid at minus 18%, the packaging particularly does not comprise any polymers.

As regards the sealing of the formed kraft paper bag or box, there are multiple options according to prior art. On the one hand, polyvinyl alcohol and/or vinyl alcohol copolymer has sealing capability itself, on the other hand a sealing wax can be applied to the kraft paper and/or kraft cardboard and/or the coating and/or the mechanically compressed paper, particularly partially, for example as spots or lines or in sections, particularly during the printing process. An example of such a polyvinyl alcohol and/or vinyl alcohol copolymer is ethylene vinyl acetate (EVA).

The coating and/or the sealing medium are particularly selected such that the packaging can on the one hand be recycled as paper, meeting the requirements of the named main components according to EU recommendations, and/or at least meets the requirements of the 1342 composting standard, particularly under the assumption that the coating and/or the sealing medium does not dissolve during recycling and has to be considered when looking at substance quantities. But it is preferred that the coating and/or the sealing medium are designed such that they do not dissolve during recycling, particularly under the 13432 composting standard.

The problem is particularly solved by a packaging for a frozen product, wherein the packaging is particularly formed of kraft paper and/or kraft cardboard and/or paper, particularly fresh fiber paper, and/or wherein the packaging is formed of at least 50 wt %, particularly 80 wt %, particularly at least 85 wt %, particularly at least 90 wt %, particularly at least 95 wt %, and/or its main component is formed of kraft paper and/or kraft cardboard and/or fresh fiber paper. This also includes the compressed paper. Particularly, the packaging comprises up to 50 wt % of compressed paper.

Particularly, the packaging comprises, particularly when cardboard is used, particularly having a grammage of 200 g/m\hat{ }2 or more, particularly 350 g/m\hat{ }2, less than 10 wt %, particularly less than 5 wt %, particularly no TMP (thermomechanical pulp) and/or less than 10 wt %, particularly less than 5 wt %, particularly no, CTMP (chemi-thermomechanical pulp) and/or less than 10 wt %, particularly less than 5 wt %, particularly no, BCTMP (bleached chemi-thermomechanical pulp) and/or has no impregnation and/or the packaging is compostable.

Particularly, the packaging comprises less than 10 wt %, particularly less than 5 wt %, particularly no, BCTMP and CTMP (BCTMP and CTMP content together less than 10 wt %, particularly less than 5 wt %) and/or the packaging comprises less than 10 wt %, particularly less than 5 wt %, particularly no, TMP and BCTMP and CTMP (BCTMP and TMP and CTMP content together less than 10 wt %, particularly less than 5 wt %).

Packagings based on cellulose are known, but these contain at least one layer of CTMP or BCTMP. It is surprisingly possible, according to the invention, to eliminate such a component, which is considered necessary in prior art but disadvantageous with respect to the environmental footprint and/or compostability, and still create a packaging suitable for frozen foods, particularly when using a coating and/or lining with compressed paper.

The problem is also solved by using kraft paper and/or kraft cardboard, particularly with a polyvinyl alcohol and/or vinyl alcohol copolymer coating, and/or mechanically compressed paper for packaging a product, particularly a frozen product, on at least an industrial-grade and/or automatic welding, filling, and/or packaging machine.

The problem is also solved by a method for producing a packaging and/or for packaging a product, particularly a frozen product, comprising the following actions:
a. Providing kraft paper and/or kraft cardboard, particularly having a polyvinyl alcohol and/or vinyl alcohol copolymer coating and/or a coating of compressed paper on at least one side, particularly exactly on one side, of the kraft paper and/or kraft cardboard;
b. Placing at least two sections and/or pieces of the kraft paper and/or kraft cardboard on top of each other, particularly in such a manner that the coatings of the sections and/or pieces contact each other, particularly at least along a line of at least 5 cm in length, particularly over an area of 5 cm², and connecting the sections and/or pieces, particularly fusing the coatings and/or fusing sealing wax applied to the coating and/or the kraft paper and/or cardboard of the sections and/or pieces, at least along a line of at least 5 cm in length, particularly over an area of 0.5 cm², thereby forming a packaging;
and particularly
c. Filling the packaging, particularly with a frozen product, particularly deep frozen;
and particularly
d. Placing at least two sections and/or pieces of the kraft paper and/or kraft cardboard on top of each other, particularly of the packaging, particularly in such a manner that the coatings of the sections and/or pieces contact each other, particularly at least along a line of at least 5 cm in length, particularly over an area of 5 cm², and connecting the sections and/or pieces, particularly fusing the coatings and/or fusing sealing wax applied to the coating and/or the kraft paper and/or kraft cardboard of the sections and/or pieces, at least along a line of at least 5 cm in length, particularly over an area of 0.5 cm², to close the packaging.

The problem is also solved by a packaged frozen product, packaged in a packaging according to the invention.

In the case of oil-containing components or product ingredients in the packaging which have a low freezing point, particularly lower than minus 15° C., a commercially available coating such as polyvinyl alcohol and/or vinyl alcohol copolymer and/or a coating of compressed paper can advantageously be applied, particularly onto the surface of the kraft paper and/or cardboard facing inwards.

As regards sealing for joining the formed kraft paper and/or cardboard bag or box, there are multiple options according to prior art. On the one hand, polyvinyl alcohol and/or vinyl alcohol copolymer has sealing capability itself, on the other hand, a sealing wax can be applied to the kraft paper and/or kraft cardboard, particularly partially, particularly during the printing process, particularly prior to forming the bag and/or box, and used for sealing, joining, and/or welding together, particularly of two layers and/or sections of kraft paper and/or kraft cardboard.

The coating and/or the sealing medium is particularly selected such that the packaging can on the one hand be recycled as “paper” and on the other hand meets at least the requirements of the 13432 composting standard.

Advantageously, the kraft paper and/or kraft cardboard is provided on at least one, particularly on exactly one, side with a coating composed of, particularly only of or 100% of, polyvinyl alcohol and/or vinyl alcohol copolymer and/or is provided on at least one, particularly on exactly one, side with a coating of compressed paper.

Advantageously, the main component is at least 50 wt %, particularly at least 80 wt %, particularly at least 85 wt %, particularly at least 90 wt %, particularly at least 95 wt % of the packaging and/or is a main component according to 94/62/EC and/or 97/129/EC. If a coating of compressed paper is used, it is sufficient if the kraft paper and/or kraft cardboard together with the compressed paper represent at least 50 wt %, particularly at least 80 wt %, particularly at least 85 wt %, particularly at least 90 wt %, particularly at least 95 wt % of the packaging and/or the main component according to 94/62/EC and/or 97/129/EC.

Particularly, the packaging is configured such that it on the one hand contains first materials, which are detached and/or dissolved in paper recycling, and on the other hand contains second materials, wherein the second materials contain at least 99% or only paper, cardboard, or compressed paper and wherein no other materials are contained in addition to the first and second materials.

Advantageously, the kraft paper and/or kraft cardboard does not have any microstructuring and/or the kraft paper and/or kraft cardboard were not microstructured, particularly not as described in EP 1 985 437 B1.

Particularly, the kraft paper and/or kraft cardboard and/or their surfaces and/or at least one surface or their structure is not undulated and/or shows no undulation.

Particularly, the packaging does not contain any corrugated cardboard and/or corrugated paper.

Particularly, the kraft paper and/or kraft cardboard and/or the paper and/or the compressed paper and/or their surfaces have a smoothness suitable for printing on.

Advantageously, the kraft paper and/or kraft cardboard, particularly when stored for at least three hours at a relative humidity of 50% or less, is not bi-elastic, particularly not elastic, particularly not more than 4%, particularly not more than 3%, particularly not more than 2% elastic in the longitudinal and/or transverse directions.

Advantageously, the kraft paper and/or kraft cardboard has a grammage of 30 to 360 g/m², particularly 50 to 80 g/m² for, particularly flexible, papers, and/or 230 to 300 g/m² for, particularly firm, cardboards, and/or a density of 650 to 800 kg/m³.

Particularly advantageously, the kraft paper and/or kraft cardboard is formed of coniferous woods, particularly long-fiber coniferous woods, particularly of spruce and/or pine, or has a content of at least 50% thereof.

Particularly advantageously, the kraft paper and/or kraft cardboard is formed of at least 90%, particularly completely of, fibers which were subjected to fibrillation.

Particularly advantageously, at least 90%, particularly the entire kraft paper and/or kraft cardboard and/or paper is produced using the sulfate method or kraft pulping, particularly by heating wood chips or crushed plant stalks in pressure vessels for three to six hours at increased pressure (7 to 10 bar) with caustic soda, sodium sulfide, and/or sodium sulfate, particularly with subsequent filtration.

Particularly advantageously, the kraft paper and/or kraft cardboard does not contain any recycled waste paper or up to 10% of recycled waste paper and/or up to 10% of recycled fibers and/or up to 10% of recycled material.

Advantageously, the kraft paper has a carbon footprint, particularly according to ecoinvent RER, of up to 1 Co2e/kg unbleached kraft paper, particularly of up to 0.85 kg Co2e/kg unbleached paper, and/or the kraft cardboard has a carbon footprint, particularly according to ecoinvent RER, of up to 1.05 Co2e/kg unbleached kraft cardboard, particularly of up to 0.95 kg Co2e/kg unbleached kraft cardboard.

In addition to the improved environmental footprint, leaving out the bleaching process also results in stability advantages.

Advantageously, the kraft paper and/or kraft cardboard is particularly suited as a packaging for frozen food. Advantageously, the kraft paper and/or kraft cardboard shows an increase in resistance to puncture by a cone, measured in Newton, by 20% in a paper of 50 g/m² and of 35% In a paper of 75 g/m² based on standard conditions and/or 50% relative humidity and particularly 23° C. after being moistened for 3 hours by 80% relative humidity, for example at 23° C.

Advantageously, the kraft paper and/or kraft cardboard, based on being stored for three hours at 50% relative humidity, particularly at 23° C., shows an increase in resistance to puncture by a cone of at least 15%, particularly of at least 30% for a grammage of more than 70 g/m² after being stored for three hours at 80% relative humidity, particularly at 23° C.

Advantageously, the packaging is closed with respect to at least five spatial directions, particularly by the kraft paper and/or kraft cardboard.

Advantageously, the packaging, particularly the kraft paper and/or kraft cardboard, encloses a volume located in the packaging on all sides.

Advantageously, the packaging has at least one joint of at least two sections and/or pieces of kraft paper and/or kraft cardboard and/or such a joint is created, wherein said joint is caused by means of a coating or sealing wax located on sections and/or pieces, particularly by fusing the same.

Advantageously, the coating and/or sealing wax are applied onto the side of the kraft paper and/or kraft cardboard facing the interior of the packaging.

Advantageously, a volume located in the packaging, particularly a material located therein, particularly comprising an oily component and/or a component of more than 5% fats which are liquid at minus 18% on its outer surface, completely enclosed by kraft paper and/or kraft cardboard with coating, wherein particularly all sides and/or surfaces of the kraft paper and/or kraft cardboard facing the volume are provided with the coating, particularly completely and/or in an areal manner. Particularly, this component has a proportion by weight of the volume located inside the packaging, particularly of material located therein, of at least 5%, particularly of at least 10%.

Advantageously, the kraft paper and/or kraft cardboard, the kraft paper and/or kraft cardboard with coating, and/or the packaging are compostable and/or biodegradable, particularly according to EN 13432 and/or EN 14995 and/or OECD 301 and/or OECD 302, particularly to at least 90%, particularly within 12 weeks in an industrial composting system according to European standard EN 13432.

Advantageously, the packaging predominantly and/or exclusively consists of unbleached kraft paper and/or kraft cardboard and/or kraft paper and/or kraft cardboard, particularly of brown color.

Advantageously, the packaging predominantly and/or exclusively consists of fresh fiber paper, particularly of brown color.

Advantageously, the packaging is closed and/or at least one frozen product is arranged in the packaging.

Advantageously, the packaging is a bag and/or a folded box.

Advantageously, the packaging comprises at least one, particularly at least two and/or three line-shaped joints of two pieces and/or sections of coated kraft paper and/or kraft cardboard and/or at least two and/or three line-shaped joints of two pieces and/or sections of kraft paper and/or kraft cardboard are created, wherein the coatings consist of a polyvinyl alcohol and/or vinyl alcohol copolymer and/or sealing wax coating and wherein the joint is formed by placing coatings of two pieces and/or sections of coated kraft paper and/or kraft cardboard on top of each other and fusing the coatings and or by a fusion of adjacent coatings of two pieces and/or sections of coated kraft paper and/or kraft cardboard.

Advantageously, the packaging and/or the at least one frozen product are deep frozen.

Advantageously, the packaging is filled and/or closed industrially and/or on a machine.

Particularly, the kraft paper and/or kraft cardboard and/or the paper has a grammage of 30 to 150 g/m² and/or a density of 650 to 800 kg/m³ and/or a tensile index L according to ISO 1924-3 between 100 and 125 Nm/g and/or a cross direction tensile index according to ISO 1924-3 between 50 and 65 Nm/g and/or mean tensile index values according to ISO 1924-3 between 80 and 95 Nm/g and/or a tensile index quota according to ISO 1924-3 between 1.7 and 2.3 Nm/g and/or a strain at break L according to ISO 1924-3 between 1.2% and 2% and/or a cross direction strain at break according to ISO 1924-3 between 2.2% and 3.4% and/or a specific bursting strength according to ISO 2758 between 4 and 6 kN/g and/or a specific tear growth resistance L according to ISO 1974 between 6 and 10 mNm²/g and/or a specific cross direction tear growth resistance according to ISO 1974 between 7 and 11 mNm²/g and/or an air permeability (Gurley) according to ISO 5636-5 between 40 and 50 s/100 ml and/or a Cobb number US (upper side) according to ISO 535 between 20 and 26 g/mL and/or a Cobb number WS (wire side) according to ISO 535 between 21 and 27 g/mL and/or a moisture between 6.3 and 8.3 wt % and/or a roughness number US (upper side) according to ISO 8791-2 between 600 and 1600 and/or a roughness number WS (wire side) according to ISO 8791-2 between 50 and 350, all ISO standards as amended at the date of filing and/or particularly at a relative humidity of 50% and/or a temperature of 23° C.

Particularly, the kraft paper and/or kraft cardboard and/or the paper has a tensile breaking strength MD (machine direction) according to PN-ENIS0-1924-2 between 3 and 10 kN/m and/or a tensile breaking strength CD (cross direction) according to PN-EN ISO-1924-2 between 1 and 5 kN/m and/or tearing resistance MD (machine direction) according to PN-EN-21974 between 150 and 1100 mN and/or tearing resistance CD according to PN-EN-21974 between 200 and 1200 mN and/or CD according to PN-EN ISO-2758 between 150 and 450 kPa and/or a Cobb66 water absorption according to PN-ISO-535 of up to 35 g/m², particularly between 15 and 35 g/m² and/or a moisture according to PN-ISO-287 between 4 and 10%, all standards as amended at the date of filing and/or particularly at a relative humidity of 50% and/or a temperature of 23° C.

Particularly, the kraft paper and/or, kraft cardboard and/or the paper and/or the coating and/or the packaging are undyed and/or food compatible.

1. A packaging for a frozen product, wherein the packaging comprises at least one layer of kraft paper and/or kraft cardboard, wherein the packaging contains less than 10 wt % CTMP and less than 10 wt % BCTMP and does not include any impregnation and is compostable; and wherein, the packaging comprises at least in sections, at least one layer of compressed paper and/or cellophane which is joined with the at least one layer of kraft paper and/or kraft cardboard.

2. The packaging according to claim 1, wherein the at least one layer of compressed paper and/or cellophane is exposed in an interior of the packaging, or wherein the compressed paper has a density in a range of from about 900 kg/m³ up to about 1300 kg/m³.

3. The packaging according to claim 1, wherein the packaging is formed of unbleached, kraft paper and/or kraft cardboard and/or fresh fiber paper or wherein the packaging contains less than 5 wt % CTMP and less than 5 wt % BCTMP.

4. The packaging according to claim 1, wherein the at least one layer of kraft paper and/or kraft cardboard is configured without a coating or without an inside coating or without a product side coating, or is coated on at least one side with a coating or lining of compressed paper having a density of more than 900 kg/m³ of polyvinyl alcohol and/or vinyl alcohol copolymer, or wherein the content of acrylates, polyvinyl alcohol and/or vinyl alcohol copolymer does not exceed 15 wt %.

5. The packaging according to claim 1, wherein a main component is at least 50 wt % of the packaging and/or or is a main component according to 94/62/EC or 97/129/EC.

6. The packaging according to claim 1, wherein the at least one layer of kraft paper and/or kraft cardboard does not have any microstructuring and/or was not microstructured and/or is not bi-elastic or more than 4% elastic in a longitudinal direction and/or a transverse direction and/or has a grammage of 30 to 360 g/m², and/or a density of 650 to 800 kg/m³.

7. The packaging according to claim 1, wherein the kraft paper has a carbon footprint according to ecoinvent RER of up to 1 kg CO2e/kg unbleached kraft paper, and/or the kraft cardboard has a carbon footprint according to ecoinvent RER of up to 1.05 kg CO2e/kg unbleached kraft cardboard.

8. The packaging according to claim 1, wherein the kraft paper and/or kraft cardboard is suited as packaging for frozen foods in that it shows an increase in resistance to puncture by a cone, measured in Newton, by 20% in a paper of 50 g/m² and by 35% in a paper of 75 g/m² compared to standard conditions of 50% relative humidity and 23° C. after being moistened for three hours by 80% relative humidity at 23° C., and/or wherein the kraft paper and/or kraft cardboard, based on being stored for three hours at 50% relative humidity at 23° C. and after being stored for three hours at 80% relative humidity, at 23° C., shows an increase in resistance to puncture by a cone of at least 15%, particularly of at least 30% for a grammage of more than 70 g/m².

9. The packaging according to claim 1, wherein the packaging has at least one joint of at least two sections and/or pieces of kraft paper and/or kraft cardboard, wherein said joint is caused by a coating located on sections and/or pieces, particularly by fusing the same, and wherein the coating is applied onto a side of the kraft paper and/or kraft cardboard facing the interior of the packaging.

10. The packaging according to claim 9, wherein a volume located in the packaging, particularly a material located therein, particularly comprising an oily component, is completely enclosed by kraft paper and/or kraft cardboard with the coating, wherein all sides and/or surfaces of the kraft paper and/or kraft cardboard facing the volume are provided with the coating, particularly completely and/or flatly over an area.

11. The packaging according to claim 9, wherein the kraft paper and/or kraft cardboard, the kraft paper and/or kraft cardboard with the coating, and/or the packaging are compostable and/or biodegradable, to at least 90% according to EN 13432 and/or EN 14995 and/or OECD 301 and/or OECD 302, within 12 weeks in an industrial composting system according to European standard EN 13432.

12. The packaging according to claim 1, wherein the packaging predominantly and/or exclusively is comprised of coated kraft paper and/or kraft cardboard and fresh fiber paper, of a brown color, and/or wherein the packaging predominantly and/or exclusively is comprised of unbleached kraft paper and/or kraft cardboard and/or of kraft paper and/or kraft cardboard of a brown color.

13. The packaging according to claim 1, wherein the packaging comprises at least one line-shaped joint of two pieces and/or sections of coated kraft paper and/or kraft cardboard, wherein the coating is a polyvinyl alcohol and/or vinyl alcohol copolymer coating and/or a coating of compressed paper, and wherein the at least one joint is formed by placing coatings of two pieces and/or sections of coated kraft paper and/or kraft cardboard on top of each other and fusing the coatings and/or applying sealing wax onto the coating and/or the kraft paper and/or kraft cardboard, and/or by a fusion of adjacent coatings and/or of sealing wax applied onto the coating and/or the kraft paper and/or kraft cardboard of two pieces and/or sections of coated kraft paper and/or kraft cardboard.

14. A packaged frozen product, packaged in a packaging comprising at least one layer of kraft paper and/or kraft cardboard, wherein the packaging contains less than 10 wt % CTMP and less than 10 wt % BCTMP and does not include any impregnation and is compostable; and wherein, at least in sections, at least one layer of compressed paper and/or cellophane is joined with the at least one layer of kraft paper and/or kraft cardboard.

15. The packaged frozen product according to claim 14, wherein the packaged frozen product is deep frozen and/or the packaging is industrially and/or automatically filled and/or closed.

16. The packaging according to claim 1, wherein the at least one layer of kraft paper and/or kraft cardboard and the at least one layer of compressed paper and/or cellophane are joined by laminating.

17. The packaging according to claim 2, further comprising a layer that is one of absorbent and repellent to moisture, particularly to water vapor; and wherein the layer is located between the at least one layer of kraft paper and/or kraft cardboard and the at least one layer of compressed paper and/or cellophane.

18. The packaging according to claim 2, further comprising a layer that is repellent to moisture and/or oil and wherein the layer is located between the at least one layer of kraft paper and/or kraft cardboard and the at least one layer of compressed paper and/or cellophane.

19. The packaging according to claim 1, wherein the packaging is formed of at least 50 wt % and/or its main component is formed of unbleached kraft paper and/or kraft cardboard and/or fresh fiber paper, and wherein the packaging contains less than 5 wt % CTMP and less than 5 wt % BCTMP.

20. The packaging according to claim 1, wherein the packaging is deep frozen, and/or the packaging is industrially and/or automatically filled and/or closed.
